(19) United States
(12) Patent Application Publication
(10) Pub. No.: US 2023/0183550 A1
(43) Pub. Date: Jun. 15, 2023

(54) BIO-DERIVED COMPLEX FOR OIL AND GAS WELL REMEDIATION

(71) Applicant: Richard Strother, Palm Beach, FL (US)

(72) Inventors: Richard Strother, Palm Beach, FL (US); Jeffrey Loch, Celebration, FL (US); Robert Stepan, Strongsville, OH (US)

(21) Appl. No.: 18/109,101

(22) Filed: Feb. 13, 2023

Related U.S. Application Data
(63) Continuation-in-part of application No. 17/682,039, filed on Feb. 28, 2022, now Pat. No. 11,608,463.
Application No. 17/682,039 is a continuation-in-part of application No. 16/863,838, filed on Apr. 30, 2020, now abandoned.
(60) Provisional application No. 62/920,478, filed on May 1, 2019.

(51) Int. Cl. C09K 8/524; C09K 8/528

(52) U.S. Cl. CPC C09K 8/524; C09K 8/528

(57) ABSTRACT

The present disclosure relates to a method for oil and gas well remediation by the creation and use of a bio-derived nano scale complex mixtures, comprising bio-derived solvents and/or surfactants that allows the breaking, dissolving, dispersing and caging of obstructions in oil and gas wells. The charge present on the bio derived nanoscale complex is based on the pH of the well. The disclosure further reduces the well obstructions to a free-flowing fluid and then encapsulates them in an electrochemical, spherical, globe of protection. The method efficiently removes obstructions from the well to be treated.

### CROSS-REFERENCE TO RELATED APPLICATIONS

This application is a continuation-in-part of U.S. patent application Ser. No. 17/682,039 filed on Feb. 28, 2022, entitled “Bio-derived complex for oil and gas well remediation,” which is a continuation-in-part of U.S. patent application Ser. No. 16/863,838 filed Apr. 30, 2020, entitled “Bio-derived complex for oil and gas well remediation” which claims priority from U.S. Provisional application No. 62/920,478 filed May 1, 2019, entitled “Method and apparatus for the use of remediation fluids” each of which is incorporated herein by reference in its entirety for all purposes.

### TECHNICAL FIELD

The present disclosure relates to a bio-derived nano scale complex and a method for oil and gas well remediation, intervention, well stimulation in well services or well work, both on shore and off-shore. The present disclosure also relates to well head maintenance and any operation carried out on an oil or gas well during or at the end of its productive life that alters the state of the well fluids, well geometry and oil reservoir. The nano scale complex comprises various combinations of bio surfactants, bio solvents and organic acids.

### BACKGROUND OF THE DISCLOSURE

Petroleum, for past many years, has been recovered from subterranean reservoirs through the use of drilled wells and production equipment. Oil and natural gas are found in, and produced from, porous and permeable subterranean formations, or reservoirs. The porosity and permeability of the formation determine its ability to store hydrocarbons, and the facility with which the hydrocarbons can be extracted from the formation. Generally, the life cycle of an oil and/or gas well includes drilling to form a wellbore, casing, cementing, stimulation, and enhanced or improved oil recovery.

In today's world of well maintenance and remediation, conventional matrix acid stimulation is used, wherein conventional acids are pumped into the formation at or below the fracturing pressure and is useful for both sandstone and carbonate reservoirs. The most common acid used is hydrochloric acid (HCl), injected at a typical concentration of 15 wt. %, but can be as high as 28 wt %. However, in high temperature applications, HCl does not produce acceptable stimulation results due to its fast reaction that leads to lack of penetration. As a matter of fact, the reaction is so rapid in high temperatures that it is impossible for the acid to penetrate more than a few inches into the formation. In addition, HCl will not dissolve quartz and alumina silicates found in sandstone reservoirs as these particles (fines) migrate into the pores of the near-wellbore area and can reduce production. Furthermore, acidizing in sandstone reservoirs can create re-precipitation of reaction products that may cause new formation damage.

U.S. Pat. No. 6,399,547 discloses a well treatment fluid comprising hydrochloric acid; water; an aliphatic aldehyde having 1-10 carbon atoms; and an aromatic aldehyde having 7-20 carbon atoms.

Further in prior conventional art, well remediation and well stimulation, the recovery of gas and oil, especially heavy crude oil, the resulting challenges were the high viscosity and vapor pockets. These challenges attenuate the delivery of heavy crude and causes lower yields. The standard remedy is to pump kerosene and/or light oil down to the clogged area. In addition, hexane, toluene, xylene and alcohols are used to mitigate the problem. The down part is that these chemicals are harmful, toxic and damaging to the environment. In addition, these chemicals are very expensive and require special handling. Further to this problem, these materials are not exceptionally effective and can result in a high cost for improved production/oil & gas recovery.

Accordingly, to overcome the disadvantages of the prior art, the present disclosure discloses innovative technology to alter either the rock permeability or the fluid viscosity in order to produce the oil at commercially competitive rates. In addition to low permeability, it addresses low API (American Petroleum Institute gravity) and high oil viscosity. Moreover, the biodegradable “green” nature of the disclosure is environmentally friendly and poses no risk to contamination of underground aquifers or drinking water tables.

The non-corrosive disclosure is safe and non-toxic, containing no volatile organic compounds (“VOCs”), versus toxic level VOCs, deadly chemicals and heavy aromatic distillates that corrode well casing in conventional methodology and persists contaminating the environment with long half-lives. In addition, there is no need for Hazmat Gear, booms and evacuation pumps that conventional methodology requires. The disclosure is therefore more cost-effective in addition to being environmentally friendly.

### BRIEF DESCRIPTION OF THE DRAWINGS

FIG. 1 shows a flowchart for the bases that contribute to one of the embodiments of the present disclosure.

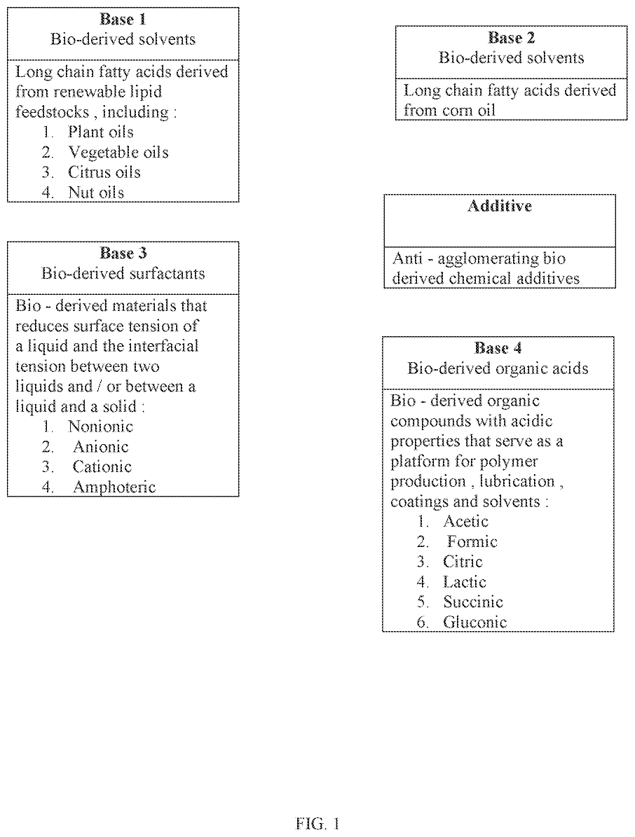

FIG. 2 shows a pictorial view of the method of dissolving, dispersing and caging for removal of obstructions in the well according to the present disclosure.

FIG. 3 shows a flowchart methodology for introducing the interrelation of the biodegradable ingredients according to the present disclosure.

### SUMMARY

Methods and compositions comprising a bio-derived nano scale complex for use in various aspects of the life-cycle of an oil and/or gas well are provided.

In one aspect, a method of treating a well is provided comprising measuring the pH of the well to be treated, breaking, dissolving, dispersing and caging of obstructions in wells using a bio-derived nano scale complex, wherein the bio-derived nanoscale complex is cationic charged when the pH of the well is less than 7.

In some embodiments, a method of treating a well is provided comprising measuring the pH of the well to be treated, breaking, dissolving, dispersing and caging of obstructions in wells using a bio-derived nano scale complex, wherein the bio-derived nanoscale complex is anionic charged when the pH of the well is greater than 7.

In some embodiments, a method of treating a well is provided comprising measuring the pH of the well to be treated, breaking, dissolving, dispersing and caging of obstructions in wells, wherein dissolving and breaking down an obstruction(s) to their lowest energy form, e.g., sphere takes place using a bio-derived nano scale complex.

In some embodiments, a method of treating a well is provided comprising measuring the pH of the well to be treated, breaking, dissolving, dispersing and caging of obstructions in wells using a bio-derived nano scale complex, wherein dispersing includes dispersing the said spheres to obtain a flowing sphere(s) of dissolved obstructions;

wherein said dispersing is a two-step process comprising

(i) flowing of a collection of spheres due to an electrostatic action of a bio-surfactant(s); and

(ii) keeping undesirable spheres from agglomerating by negative attractions of the bio-surfactant(s), while the spheres are swept away from well perforations.

In some embodiments, a method of treating a well is provided comprising measuring the pH of the well to be treated, breaking, dissolving, dispersing and caging of obstructions in wells using a bio-derived nano scale complex, wherein caging includes caging the flowing spheres of dissolved obstructions to obtain a segregated cage(s) and sweeping the segregated cages of obstructions to the surface of the well for disposal.

In another aspect, the present disclosure relates to a bio-derived nano scale complex comprising a first solvent derived from a vegetable oil; a second solvent derived from bio-based feedstock; an anti-agglomerating additive; a bio-surfactant in the range of 15 to 50 wt % with respect to total weight of the composition; and an organic acid.

In some embodiment, the first solvent is in the range of 15 to 75 wt % with respect to total weight of the composition. The vegetable oil in first solvent further comprises at least one fatty acid selected from saturated fatty acids and unsaturated fatty acids or combinations thereof.

In some embodiments, the solvents derived from vegetable oil comprise a mixture of fatty acids, wherein the fatty acids are organic carboxylic acids with long aliphatic chains. The fatty acids are saturated (containing only C—C single bonds) fatty acids or unsaturated fatty acids (containing multiple bonds between carbon atoms).

In some embodiments, the nano scale complex is present in a new physio-chemical structure of high thermal stability and chemistry. The complex comprises a mixture of bio-derived solvents which are combined with anti-agglomerating compounds and a variety of surfactants.

In another embodiment, the anti-agglomerating additive is in the range of 0.1 to 10 wt % with respect to total weight of the composition. The anti-agglomerating additive is selected from unsaturated methyl esters, unsaturated di-substituted amides.

In some embodiments, the surfactant is a bio-derived anionic, and/or nonionic, and/or cationic and/or amphoteric surfactant.

In some embodiments, the organic acid is in the range of 0.1 to 50 wt % with respect to total weight of the composition. The organic acid is at least one selected from acetic acid, formic acid, citric acid, lactic acid, succinic acid, gluconic acid or combinations thereof.

In one aspect of the present disclosure, the bio-derived nano scale complex is used in deconstructing at least one compound with long carbon chains selected from paraffin, asphaltene, scales, mud cake, emulsion, retrograde condensation from open-hole perforations, formation of sandstone and carbonates.

Other aspects, embodiments, and features of the methods and compositions will become apparent from the following detailed description when considered in conjunction with the accompanying drawings. All patent applications and patents incorporated herein by reference are incorporated by reference in their entirety. In case of conflict, the present specification, including definitions, will control.

### DETAILED DESCRIPTION

The present disclosure discloses compositions and methods for oil and gas well remediation by the creation and use of non-conventional bio-derived nano scale complex mixtures, including bio-derived solvents and/or surfactants that allow the breaking, dissolving, dispersing and caging of obstructions in oil and gas wells, pipeline storage and mixing facilities. The bio-derived readily biodegradable nano scale complex mixtures are formulated to allow the breaking and dissolving of any high molecular weight organic matter.

For convenience, certain terms employed in the specification, examples, and appended claims are listed here. However, phraseology and terminology employed herein is for purpose of description and should not be regarded as limiting and one of ordinary skill in the art, given the present specification, would be capable of making and using the presently claimed and disclosed disclosure in a broad and non-limiting manner.

‘Stimulation’ refers to the removal of unwanted deposits from the wellbore and production equipment.

‘Well stimulation’ refers to a well intervention performed on an oil or gas well to increase production by improving the flow of hydrocarbons from the drainage area into the well bore.

‘Well remediation’ refers to the treatment of geological formations to improve the recovery of hydrocarbons from well damage and arterial blockage caused by the precipitation and deposition of heavy organic molecules from petroleum fluids.

‘pH’ refers to a figure expressing the acidity or alkalinity of a solution on a logarithmic scale on which 7 is neutral, lower values are more acid and higher values more alkaline. The pH is equal to −log 10 c, where c is the hydrogen ion concentration in moles per liter.

‘Measuring pH of well’ refers to measuring the pH of the crude oil and contaminants within the well.

‘Well(s)’ refers to oil and gas wells, pipeline storage and mixing facilities.

‘Nano scale complex’ refers to a water-in-oil (W/O), oil-in-water (O/W) and other classes of nano-emulsions which have been found beneficial in drilling, completion, well remediation and other oil and gas industry related operations.

‘Surfactants’ refers to ‘surface-active agents’ which are molecules that contain a hydrophilic, or “water-loving” end, and a hydrophobic, or “water-fearing” end.

‘Asphaltenes’ refers to aromatic-based hydrocarbons of amorphous structure. They are present in crude oils in the form of colloidally dispersed particles. They deposit in near wellbore subterranean formations, in well tubing and perforations, and in transfer lines, storage tanks, surface equipment, pipelines hinder production and transport of high asphaltene crudes from wells.

‘Bio-based feedstock’ refers to a source from which oil is obtained. The bio-based feed stock includes but is not limited to oil derived from animals, microorganisms, bacteria, fungi, algae, plants and vegetables. The bio-based feedstock generally excludes synthetically derived oil or mineral oil.

In one aspect, the present disclosure provides a nano scale complex which comprises a first solvent comprising plant oil and second solvent derived from bio based feedstock combined with anti-agglomerating compounds and a variety of bio-derived surfactants and organic acids.

In one embodiment, the first solvent is a mixture of fatty acids derived from plant source. The fatty acids are saturated or unsaturated fatty acids; wherein saturated fatty acids are selected from, but not limited to, palmitic acid, stearic acid etc. and unsaturated fatty acids are selected from, but not limited to, oleic acid, linoleic acid, erucic acid, linolenic acid etc.

In one embodiment, the fatty acids are derived from (1) vegetable oils and plant oils including corn, canola, soybean, palm, coconut, safflower, sunflower, rapeseed, cottonseed, and rice oils, (2) nut oils, including peanut, almond, beech, brazil, cashew, hazelnut, macadamia, pecan, pine nut, pistachio, pumpkin seed, and walnut oils; and (3) citrus oils, including lemon, lime and orange oils.

In one embodiment, the first solvent is in the range of 15 to 75 wt % with respect to total weight of the composition, preferably in the range of 25 to 60%. Further, the ratio of saturated fatty acid to unsaturated fatty acids is in the range of 1:3 to 1:5.

In one embodiment, the second solvent is a mixture of fatty acids derived from biobased feedstock. The second solvent is oil derived from at least one biobased feedstock selected from the bio-based feedstock is at least one source selected from animal, plants fungi, algae, microorganisms, or any combinations thereof, more particularly the second solvent is corn oil. The second solvent is in the range of 5 to 50 wt % with respect to total weight of the composition. preferably in the range of 15 to 45%.

In one embodiment, the anti-agglomerating compounds are selected from unsaturated methyl esters, unsaturated di-substituted amides or combinations thereof. The anti-agglomerating additive is in the range of 0.1 to 10 wt % with respect to total weight of the composition. The methyl ester and amides act as a solvent and dissolver in well remediation.

The bio-derived surfactants are anionic, nonionic, cationic or amphoteric or combinations thereof. The bio-derived surfactants further include (a) nonionic ethoxylates, alkoxylates and cocamides; (b) anionic compounds, including linear alkyl-benzene sulfonates, alpha-olefin sulfonates and alcohol ether sulfates; (c) cationic compounds; and (d) amphoteric compounds or derivatives thereof. The bio-surfactant in the range of 15 to 50 wt % with respect to total weight of the composition. The proportion of bio surfactant depends on the pH of the well or area to which the nano scale complex is applied. The bio-derived surfactants reduce the surface tension of a liquid and the interfacial tension between two liquids and/or between a liquid and a solid.

In one embodiment, the bio-derived organic acids are selected from, but not limited to, acetic, formic, citric, lactic, succinic and gluconic acids. The organic acid is in the range of 0.1 to 50 wt % with respect to total weight of the composition. These bio-derived organic compounds with acidic properties serve as a platform for polymeric substances production, lubrication, coatings, and solvents.

In one of the embodiments, the nano scale complex may optionally comprise one or more of terpenes, furans, ethers, alcohols, alkanes, aromatic phenolics. The terpenes are large and diverse organic compounds with strong aromatics. Furans, ethers, alcohols, alkanes and aromatic phenolics are well-known organic compounds.

The long lasting nano scale complex has a high flash point and retains heat, allowing the product to penetrate beyond the perforations and deep into the formation to repair it without creating new damage, dissolve obstructions, expand/extend the pores, improve permeability (water wet the formation), reduce surface and interfacial tension, to prevent emulsions and to ultimately increase production, thus avoiding the many complex and environmental issues resulting from the usage of toxic acids, including HCl.

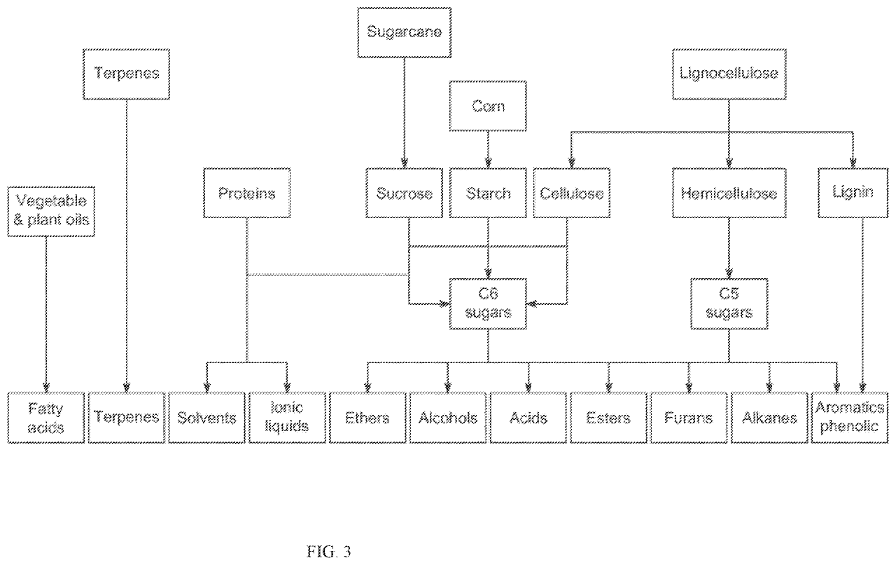

The bio-derived nano scale complex mixtures are formulated in 11 steps as set forth in FIG. 3 to allow the breaking and dissolving any high molecular weight organic matter, which can be applied by one of ordinary skill in the art.

In one embodiment, the present nano scale complex which is bioderived has multiple applications including but not limited to well remediation or stimulation, cleaning oil storage tanks, transportation tankers, oil and gas pipelines, sludge ponds, and oil pipelines in refineries. In preferred embodiment, the bioderived nanoscale complex is used for well remediation or stimulation. In another aspect, the disclosure further relates to a method of gas and oil well remediation comprising the step of:

(a) Measuring pH of the well: The pH of well is measured which refers to pH of crude oil and other contaminants within well. If the pH is low, the bio-derived nanoscale complex is cationic (+) charged and if pH is high the bio-derived nanoscale complex is anionic (−) charged.

(b) Dissolving: The disclosure employs a versatile, broad range molecule in specifically engineered compositions that break down the aromatics, paraffin and asphaltene—literally exploding them apart. This complementary, complex, composition of a bio-derived solvent, surfactant and potent surface acting agent(s) all work in concert to melt and reduce the contaminants to their lowest energy form—a sphere. As part of the naturally occurring separation, the larger spheres gather together in suspension from the smaller spheres.

(c) Dispersing: At this point, due to the electrostatic action of the free energy surface acting agent, the collection of spheres begins flowing. The negative attractions of these agents keep the undesirable spheres from agglomerating while they are swept away from the perforations. The flowing spheres gravitate towards the positive attraction of cages which are composed of sub-micron particles.

(d) Caging: Much like a paperclip that is attracted to a magnet, the flowing spheres of dissolved obstructions become “locked” in a spherical globe of electrochemical protection. These segregated and now harmless cages of hard mineral salts such as calcium, magnesium and other contaminants which are swept to the surface of the well for disposal.

In some embodiments, the bio derived nanoscale complex is cationic (+) charged if the pH of the well is less than 7, wherein the bio derived nanoscale complex is anionic (−) charged if the pH of the well is greater than 7.

In some embodiments, the present disclosure dissolves obstructions, disperses them into nanoparticles, cages them electrostatically, meanwhile acting in the 24 hour soaking, the perforations and oil reservoir, lubricating them mostly with vegetable oil, then removing or vacuuming the solution into a baker truck for disposal before the well is reopened. Meanwhile, the casing is lubricated by a combination of bio surfactants.

The present disclosure is, especially, formulated to treat specific precipitation obstructions such as asphaltenes, paraffin and scale within and near the wellbore resulting into improved permeability, shrinked clay swelling, removal of soil film on rocks, restoring of water wet pores and diluting and deconstructing long chain impeding molecules.

The disclosure further stimulates production of sandstone deposits, carbonate reservoirs and heavy and extra-heavy oil deposits. It is useful in cleaning production pipes and removal of damage in gas fields.

The powerful disclosure takes solid chemical obstructions in oil and gas wells as well as related transport, blending, and storage facilities and quickly reduces the obstructions to a free-flowing fluid and encapsulating them in an electrochemical, spherical, globe of protection. The sub-micron particles are then corralled, extracted and disposed of, leaving a lubricated casing surface for increased flow and output of crude oil or gas.

Thermal stable methods are used to allow production of exceedingly viscous oil. Such hydrocarbons are called viscous or “heavy oil” as the methods of present disclosure retain heat, dissolve the obstructions, penetrate deep into the formation and are able to deconstruct the long carbon chains (C:60-C:80) such as asphaltenes. Moreover, the biodegradable “green” nature of the disclosure is environmentally friendly and poses no risk to contamination of underground aquifers or drinking water tables. Moreover, the disclosure is “Green” in that it is made from bio-derived, degradable, renewable natural materials with no volatile organic compounds (VOC), no CO₂ emissions and no Hazmats protocols normally used in well treatment. It is environmentally friendly and represents no hazard to drinking water tables as it is injected underground into the wells.

According to an embodiment of the disclosure, the viscosity of heavy crudes with low API's and inoperable transport viscosity can be increased and thus enabling the use of methods of transport heretofore unavailable to such heavy crudes.

In one of the embodiments, once an oil well is vetted for its length, volume and capacity, as well as the well's type of reservoir formation of sand or rock or clays by one of ordinary skill in the art, a balanced composition according to the present disclosure, i.e. biodegradable and “Green” solvent, surfactant product of nano-particles, is poured down the well bore in order to enhance oil recovery from seasoned oil wells which are under-producing due to obstructions and lack of mobility in the reservoirs.

In another embodiment, organic obstructions (incrustations) such as wax, paraffins, asphaltenes and dirt are formed over time in production pipes, diminishing their diameter, restricting oil flow and in oil reservoirs, restricting pores and channels, causing oil to reduce its movement and flow, consequently diminishing well production. Then, nano scale complex mixtures invade organic obstructions in well production pipes and in oil reservoirs, dissolving them into a free-flowing liquid. Once pores and channels in reservoirs are cleaned, they are also coated so that they cannot easily form incrustations again and this allows oil to flow freely, increasing pressure, permeability and mobility while reducing viscosity, all of which increases oil mobility and can restore oil well production back to its historical “peaks”. In essence, it reinvigorates oil reservoirs. The nano scale complex penetrates much deeper into oil reservoirs, lasting many times longer than the currently hazardous toxic, acid and corrosive injection solvents used in the prior art.

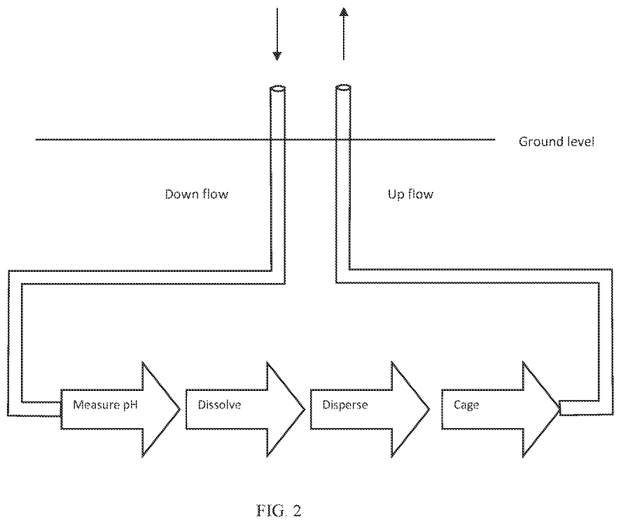

The obstructions are dissolved, caged and dispersed (as shown in FIG. 2) and are vacuumed up with the fluids and placed in a holding tank for removal. The well is then put back into service.

In one of the embodiments, the present disclosure provides a biodegradable nanotechnology fully adjusted to environmental regulations, recovery of the production potential of oil and gas producing wells, cleaning and removal of fillers and incrustations in production pipes, lengthening, and improving the useful life of the well.

In a further embodiment, the nano scale complex that penetrate deep between heavy asphalt and ground earth to efficiently lower the viscosity increases dramatically the yield of heavy organic oil products and also the break up and solubilization of the heavy crude. Additionally, reactive biodegradable organic oil derivative is used in the process that works by penetrating the adhesion between the heavy crude and the ground. The process chemically reacts with the heavy crude to enhance bio-derived surfactants in situ. As a result, this increases the ability of the water-based disclosure to lower the adhesion, surface tension and resulting friction of the heavy crude leads to a more flowable extractable product.

Heavy Crudes with low API's and inoperable transport viscosity can be combined with certain aspects of the disclosure to increase viscosity and thus be able to use pipelines or other methods of transport unavailable to heavy crudes with low viscosity and tar-like qualities.

The nano scale complex of the present disclosure increases API of heavy by breaking down heavy carbon chains that helps to reduce the viscosity and flowing of obstructions with nano scale complex to the surface of the well. The nano scale complex enhances mobility by reducing the crude oil's density, which in turn, increases the crude oils' API. Unlike severe changes in temperatures which may temporarily achieve the same results, the permanent deconstructing the long chain hydrocarbons (asphaltenes C40-C80) as low API crude oils are typically high in carbon, cracking the resins and releasing the existing toluene and n-heptane once walled off behind the resins subsurface back into the crude. The nano scale complex also breaks down the “water-in-oil” emulsion (water=API 10) while dropping out the solids & salts (all of which add to the crude's viscosity) downhole before flowing up to the surface as a less dense/higher API specific gravity fluid. The results in reduction of density and increase in API specific gravity permanently.

These and other aspects of the present disclosure will be further appreciated upon consideration of the following Example(s), which are intended to illustrate certain particular embodiments of the disclosure but are not intended to limit its scope, as defined by the claims.

### Example 1

### Mobility Enhancement Test

The experimental and core conditions are shown in Table 1 to reflect the enhancement in mobility by performing mobility change tests within the porous medium.

TABLE 1

| | | | | Initial | Final |
|---|---|---|---|---|---|
| | | | | Differential | Differential |
| Core Conditions | | Experimental Conditions | | (%) | (%) |
| Core type | BEREA | Pore pressure (psi) | 700 | | |
| Sand | UN- | Confinement pressure | 1000 | | |
| | consolidated | (psi) | | | |
| Porosity (%) | 20 | Transducer calibration | 500 | | |
| | | (psi) | | | |
| Permeability (mD) | 1000 | Temperature (F.) | 150 | | |
| Depth (pies) | | Overbalance pressure | | 6.9 | 5.5 |
| | | (psi) | | | |
| Well | PJS05 | Mud injected pressure | | 6.9 | 5.4 |
| | | (psi) | | | |
| Porous volume | 20 | Pressure level of plaster | | 6 | 5.4 |
| (cc) | | (psi) | | | |
| Length (cm) | 6 | Injection rate (cc/min) | 1 | 6.8 | 5.3 |
| Diameter (cm) | 3.753 | Fluid 1 (cc) | | 6.7 | 5.3 |
| Area (cm²) | 11.784 | Fluid 1 (cc) | | | |
| | | Fluid 2 (cc) | | | |
| | | Fluid 3 (cc) | | | |

Observations

| | |
|---|---|
| Differ. Initial Pressure (psi): 33.5 | Differ. Pressure Final (psi): 26.5 |
| Initial Mobility (md/cp): 3.723 | Mobility Final (md/cp): 5.100 |
| % Damage to the Formation: −31.01% | % Return to Permeability: 131.01% |

### Results

The composition of the present disclosure takes solid obstructions and quickly reduces them to a free-flowing liquid. The sub-micron particles are corralled and then encapsulated in an electrochemical, spherical globe of protection. In other words, the present disclosure uses electrochemical principles to bring sustainable productivity and good health to the well. Hence, the assortment of products provides full range effectiveness from hard inorganics that would naturally agglomerate and remove them from the well.

### CONCLUSION

The results obtained during the tests of mobility within the porous medium, with radial displacement methodology in core subjected to equivalent pore pressure and simulation temperature gave affirmative results, since the fluid system is of direct emulsion type with high physicochemical stability, creates an obvious reaction of ultra-low interfacial tensions, and the incorporation of broad molecular chain organic systems such as heavy and extra heavy crudes, which induces physico-chemically to perform an early stimulation inside and outside the porous medium, which translates into a modification of its mobility, or increase in the speed of displacement of crude oil, within the porous medium, which brings a benefit action at the level of immediate production of the wells treated with the present disclosure, which is characterized by an electrochemical modification of the system creating a double electric layer by the presence of a mix of surfactants of various natures, which couples in organic modules of long chains, shielding the natural feature inside and outside; wherein the reservoir creates a reaction inside the petro physics of the deposit, and outside of it, in the innate crude itself of formation.

### Example 2

### Effect of Well pH and Charge of Bioderived Nanoscale Complex

A number of bioderived nanoscale complex were prepared wherein the charge of the nanoscale complex is based on the pH of the well to check the displacement of obstructions from the well using the method described above. The results are provided in Table 2.

TABLE 2

| Bio derived | | | Displacement of |
|---|---|---|---|
| nanoscale complex | pH of Well | Charge | obstructions |
| Sample 1 | 3 | Cationic | 80% |
| Sample 2 | 3 | Anionic | 50% |
| Sample 3 | 7 | Non-Ionic | 74% |
| Sample 4 | 7 | Cationic | 65% |
| Sample 5 | 11 | Cationic | 46% |
| Sample 6 | 11 | Anionic | 82% |

### Results

The table 2 clearly shows the effect of measuring pH of well and its correlations with the preparation of bio derived nanoscale complex. The cationic charge of the bio derived complex when pH of well is 3 and anionic charge of the bio derived complex when pH of well is 11 efficiently removes the obstructions from the well to be treated.

### Example 3

### Composition of Bioderived Nanoscale Complex

A number of bioderived nanoscale complexes were prepared for well remediation using different components of the bioderived nanoscale complex according to one embodiment of the present disclosure. The compositions are provided in Table 3.

TABLE 3

| Bio derived | | | Anti | | |
|---|---|---|---|---|---|
| nanoscale | First | Second | agglomerating | | Organic |
| complex | solvent | solvent | additive wt % | Biosurfactant | acid |
| Sample 1 | Palmitic acid | Corn oil | unsaturated | Cationic | lactic acid + |
| | Linolenic | | methyl esters | | succinic acid |
| | acid | | | | |
| Sample 2 | Stearic acid | Algal oil | unsaturated | anionic | acetic acid + |
| | | | methyl esters + | | formic acid |
| | | | unsaturated | | |
| | | | di-substituted | | |
| | | | amides | | |
| Sample 3 | Stearic acid + | Fungal oil | unsaturated | Nonionic | Gluconic |
| | Euric acid | | di-substituted | | acid |
| | | | amides | | |
| Sample 4 | Oleic acid + | Bacterial | unsaturated | amphoteric | Formic acid |
| | linoleic acid | oil | methyl esters | | |
| Sample 5 | Palmitic acid | Bran oil | unsaturated | Cationic + | acetic acid + |
| | | | di-substituted | anionic | citric acid |
| | | | amides | | |
| Sample 6 | Steric acid + | Soybean | unsaturated | Nonionic + | acetic acid + |
| | euric acid | oil | di-substituted | amphoteric | gluconic acid |
| | | | amides | | |

### Example 4

### Effect Bioderived Nanoscale Complex on Well Remediation

A number of bioderived nanoscale complexes were prepared for well remediation to check the displacement of obstructions from the well using the method described above. The results are provided in Table 4.

TABLE 4

| Bio | | | Anti | | | |
|---|---|---|---|---|---|---|
| derived | First | Second | agglomerating | | Organic | |
| nanoscale | solvent | solvent | additive | Biosurfactant | acid | Displacement of |
| complex | wt % | wt % | wt % | wt % | wt % | obstructions |
| Sample 1 | 15 | 50 | 1 | 24 | 10 | 70% |
| Sample 2 | 20 | 40 | 4 | 16 | 20 | 68% |
| Sample 3 | 36 | 22 | 0.1 | 15 | 26.9 | 74% |
| Sample 4 | 18 | 20 | 5 | 7 | 50 | 75% |
| Sample 5 | 30 | 9.9 | 10 | 50 | 0.1 | 56% |
| Sample 6 | 54.8 | 5 | 0.1 | 40 | 0.1 | 81% |

### Results

Table 3 clearly shows the effect of bio derived nanoscale complex in well remediation. The ability pf bio derived nano scale complex to displace the obstruction in well due to the synergistic effect between the content of the bio derived nanoscale complex which efficiently removes the obstructions from the well to be treated.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teaching of the present disclosure is/are used. Those skilled in the art will recognize or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto; the disclosure may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or lists of elements, and, optionally, additional unlisted items. Only terms clearly indicated to the contrary, such as “only one of” or “exactly one of,” or, when used in the claims, “consisting of,” will refer to the inclusion of exactly one element or a list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A bio-derived nano scale complex for comprising:
a first solvent derived from a plant oil;
a second solvent derived from bio-based feedstock;
an anti-agglomerating additive;
a bio-surfactant in the range of 15 to 50 wt % with respect to total weight of the composition; and
an organic acid.

2. The bio-derived nano scale complex as claimed in claim 1, wherein the first solvent is in the range of 15 to 75 wt % with respect to total weight of the composition.

3. The bio-derived nano scale complex as claimed in claim 1, wherein the plant oil in first solvent further comprises at least one fatty acid selected from saturated fatty acids and unsaturated fatty acids or combinations thereof.

4. The bio-derived nano scale complex as claimed in claim 3, wherein the ratio of saturated fatty acid to unsaturated fatty acids is in the range of 1:3 to 1:5.

5. The bio-derived nano scale complex as claimed in claim 1, wherein the saturated fatty acids in said first solvent are selected from palmitic acid, stearic acid and unsaturated fatty acids in said first solvent are selected from oleic acid, linoleic acid, erucic acid, linolenic acid.

6. The bio-derived nano scale complex as claimed in claim 1, wherein the second solvent is in the range of 5 to 50 wt % with respect to total weight of the composition.

7. The bio-derived nano scale complex as claimed in claim 1, wherein the bio-based feedstock is at least one source selected from animal, plants fungi, algae, microorganisms, or any combinations thereof.

8. The bio-derived nano scale complex as claimed in claim 1, wherein the anti-agglomerating additive is in the range of 0.1 to 10 wt % with respect to total weight of the composition.

9. The bio-derived nano scale complex as claimed in claim 1, wherein the anti-agglomerating additive is selected from unsaturated methyl esters, unsaturated di-substituted amides.

10. The bio-derived nano scale complex as claimed in claim 1, wherein the bio-surfactants are selected from anionic, nonionic, cationic, amphoteric or any combinations thereof.

11. The bio-derived nano scale complex as claimed in claim 1; wherein the bio-surfactants are selected from ethoxylates, alkoxylates, cocamides, linear alkyl-benzene sulfonates, alpha-olefin sulfonates, alcohol ether sulfates or derivatives thereof.

12. The bio-derived nano scale complex as claimed in claim 1, wherein the organic acid is in the range of 0.1 to 50 wt % with respect to total weight of the composition.

13. The bio-derived nano scale complex as claimed in claim 1, wherein the organic acid is at least one selected from acetic acid, formic acid, citric acid, lactic acid, succinic acid, gluconic acid or combinations thereof.

14. The use of bio-derived nano scale complex of claim 1 in deconstructing at least one compound with long carbon chains selected from paraffin, asphaltene, scales, mud cake, emulsion, retrograde condensation from open-hole perforations, formation of sandstone and carbonates.
